(19) United States
(12) Patent Application Publication
(10) Pub. No.: US 2014/0170238 A1
(43) Pub. Date: Jun. 19, 2014

(54) Antimicrobial effects in polymers

(71) Applicant: BASF SE, Ludwigshafen (DE)

(72) Inventors: Nancy Nase Cliff, Ringwood, NJ (US); Bingham Scott Jaynes, New City, NY (US); Zhiqiang Song, Newtown, CT (US); Allison Guinta, Dobbs Ferry, NY (US); Elke Feese, Morristown, NJ (US); Matthew Edward Gande, Norwalk, CT (US)

(21) Appl. No.: 14/108,955

(22) Filed: Dec. 17, 2013

Related U.S. Application Data
(60) Provisional application No. 61/738,724, filed on Dec. 18, 2012.

(51) Int. Cl. C09D 5/14

(52) U.S. Cl. CPC C09D 5/14
USPC 424/618

(57) ABSTRACT

This application is directed to compositions of particular combinations of antimicrobial components which may be incorporated into a polymeric molding compositions or polymeric coating compositions. The antimicrobial components include a alkylaminoalkyl(meth)acrylate polymer (b) and antimicrobial metal (a) containing components which lead to improved antimicrobial effects. The compositions are of special interest to durable touch surfaces found in hospitals and clinics. The compositions are also suitable for use in biomaterials such as catheters and the like.

This application takes the benefit of U.S. provisional application No. 61/738,724 filed Dec. 18, 2012, the contents of which is herein incorporated entirely by reference.

### FIELD OF THE INVENTION

This application is directed to coating and molding polymer compositions which comprise combinations of antimicrobial alkylaminoalkyl(meth)acrylate polymers and antimicrobial metal containing compounds and the surprisingly improved antimicrobial effects shown by the compositions containing the combinations.

### BACKGROUND

It is well known to add antimicrobial compounds to coatings (see for example US published applications 2011/0077363 and US 2010/0204357) and to polymeric matrices. Additionally, it is known to add antimicrobial compounds to coatings for medical devices and medical textiles such as in co-pending U.S. application Ser. Nos. 13/527,972 and 13/528,289 Additionally U.S. Pat. Nos. 7,520,897, 6,585,989 teach combinations of antimicrobials such as silver and triclosan in polymeric matrices which give unexpected effects.

Furthermore, the literature suggests combinations of certain antimicrobial polymers in combination with silver (ie. Langmuir, 2006, 22, 9820-9823, Biomacromolecules, 2008, 9, 2677-2681, Macromol. Rapid Commun. 2009, 30, 1350-1355 and ACS Applied Materials and Interfaces, 2012, 4, 460-465).

But until now, the additives that were appropriate for use in polymeric coating compositions or polymeric molding compositions, for example durable touch surfaces, were either slow-acting (e.g. silver ions), effective only against one or two bacteria, or had low effectiveness (<log 3 reduction) in quick-kill tests at practical concentrations.

### SUMMARY OF THE INVENTION

The inventors have achieved a surprising antimicrobial synergistic effect on surfaces through the use of combinations of (a) an antimicrobial metal containing additive and (b) polymeric poly alkylaminoalkyl(meth)acrylate (the synergist) wherein (a) and (b) reside within a coating composition or within a polymeric molding composition for example for an articles of manufacture.

Combinations of these two additives exhibit a far superior antimicrobial activity on surfaces (total kill/log 6 reduction) in a short time frame (2 hours) against a variety of bacteria, including both gram positive and gram negative bacteria verses much higher concentrations of either additive alone.

It is also quite surprising that when the two additives (a) and (b) are incorporated into a bulk polymeric matrix for molding, for example a thermoplastic matrix different than (b), that the incorporation gives a synergistic antimicrobial effect which is seen on the surface even though the incorporation of the additives (a) and (b) is into the bulk of the polymer matrix for molding. Furthermore, the combination of (a) and (b) into coatings or polymer systems allows for more cost-effective levels of the two additive (a) and (b). While the reason for this improved effect is not well understood, it is believed that the (b) component works as a synergist on the antimicrobial metal, making possible lower concentrations of antimicrobial metal but with an increased antimicrobial activity.

Thus the present application is directed to an antimicrobial polymeric coating composition or a polymeric molding composition comprising
(a) an antimicrobial metal, preferably silver, especially ionic silver,
(b) about 0.1 to about 20, preferably 1 to 12 wt. % of a first polymer containing a monomer unit of formula (I)

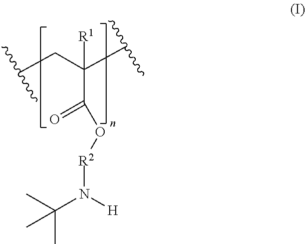

wherein R¹ is H or CH₃,
R² is C₁-C₅ alkyl bi-radical,
and
n is a number from 3 to 10,000;
(c) a second polymer which is a film-forming polymer or a thermoplastic polymer, and
(d) optionally a quaternary ammonium compound,
   wherein the wt. % is based on the total weight of (c) and (c) is different than the first polymer of component b).

Further encompassed by the application is a process for imparting antimicrobial activity to a surface, which comprises combining (a), (b), (c) and optionally (d) to form a polymeric coating or polymeric molding composition,
wherein
(a) is an antimicrobial metal, preferably silver, especially ionic silver
(b) is about 0.1 to about 20, preferably 0.1 to 12 wt. % of a first polymer containing a monomer unit of formula (I)

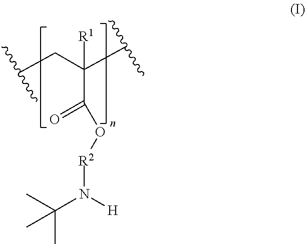

wherein R¹ is H or CH₃,
R² is C₁-C₅ alkyl bi-radical,
and
n is a number from 3 to 10,000;
(c) is a second polymer which is a film-forming polymer or a thermoplastic polymer,
and
(d) optionally a quaternary ammonium compound,
wherein the wt. % is based on the total weight of c) and c) is different than the first polymer of component b)

Also envisioned is:

Use of a combination of the antimicrobial metal (a), preferably silver, especially ionic silver with (b) the first polymer comprising a monomer unit of formula (I) and (c) and optionally (d) to improve the antimicrobial effectiveness of a polymeric coating composition or a polymeric molding composition.

A Masterbatch:

An antimicrobial metal (a) ionic silver in combination with (b) the first polymer containing a monomer unit of formula (I), preferably a homopolymer of tBAEMA and (c) a thermoplastic polymer,

wherein the wt. ratio of (b) to (a) when (a) is from about 40 to 1, preferably about 35 to 15 to 1 and (c) a thermoplastic makes up about 10 to about 98, preferably about 50 to about 95 wt. %, preferably about 60 to about 80 wt. % and the wt. % is based on the total weight of the masterbatch.

What is meant by 35 to 15 to 1 is meant that the (b) can be 35 and (a) 1 or (b) may be 15 and (a) 1.

### DETAILED DESCRIPTION OF THE INVENTION

Monomer for purposes of this application means an ethylenenically unsaturated compound before polymerization.

A monomer unit on the other hand, is a term used to describe the monomer after polymerization. The term “repeat unit” and “monomer unit” may be used interchangeably.

Polymeric molding compositions means for purposes of this application, a shaped polymeric material, for example a bulk polymer which is shaped via extrusion, spinning, rotomolding, blow molding and like into any form which may be useful as an article of manufacture (fiber, film, shaped plastic article, bottle, sheet, nonwoven etc.).

The “compositions” of the invention are polymeric compositions. The compositions are either a coating or a polymeric molding composition. The coating will contain a film forming polymer (c) or alternatively the molding composition will contain a thermoplastic polymer in which components (a), (b), (c) and optionally (d) are present.

The polymeric coating composition or polymeric molding compositions once formed are water-insoluble. Therefore the polymeric coating or polymeric molding compositions maintain their integrity when in the presence of water.

The term “film-forming polymers” refers to polymers that can form a self-supporting continuous film on at least a horizontal surface of a substrate upon removal of any diluents or carriers present in the composition or upon curing at ambient or elevated temperature.

Film-forming polymers that may be used in the coating compositions of the present application include, without limitation, those used in automotive OEM coating compositions, automotive refinish coating compositions, industrial coating compositions, architectural coating compositions, coil coating compositions, protective and marine coating compositions, and aerospace coating compositions, among others. Film-forming polymers may be crosslinked and thermosetting but not necessarily so.

Thermosetting refers to polymer or resins that “set” irreversibly upon curing or crosslinking where the polymer chains of the polymeric components are joined together by covalent bonds.

A thermoplastic polymer for purposes of this application means polymeric components not joined by covalent bonds and can therefore undergo liquid flow upon heating and are suitable for shaping or molded under heat conditions. The shaping normally takes place under heat but upon cooling to room temperature the shape of mold will solidify to form useful articles of manufacture.

“Comprising” for purposes of the invention is open ended, that is other components may be included. Comprising is synonymous with containing or including.

All percentages herein are based on weight unless otherwise noted.

When the term “molecular weight” is used this will normally indicate weight average molecular weight (Mw) unless otherwise indicated.

(Meth)acrylate means methacrylate or acrylate and likewise (meth)acrylamide means methacrylamide or acrylamide.

“Surfaces” for purposes of this application means surfaces which are exposed to air and water and may collect bacteria, for example, surfaces which have hand-contact in hospitals, home and public environs. Such surfaces would also include computer keyboards, bed guards, light switches, door handles, shopping cart handles, equipment housing and the like.

“Improved or surprising effects” for purposes of this application applies to the effect achieved from the combination of the antimicrobial additives (antimicrobial metal or (a)+alkylaminoalkyl(meth)acrylate polymer or (b)). The improved or surprising effect is that effect which is shown by a combination which exceeds the additive effect for the single components, i.e. the effect is greater than the equivalent volume or concentration of either component alone.

“Substrates” for purposes of the invention are of all kinds, e.g. wood, textiles, paper, ceramics, glass, glass fibers, plastics, polymers, such as polyester, polyethylene terephthalate, polyolefins or cellulose acetate, especially in the form of films, and also for metals such as Al, Cu, Ni, Fe, Zn, Mg or Co and GaAs, Si or SiO₂, to which there is to be applied a protective layer, coating or an image by image-wise exposure.

As used herein, the following terms have the designated definitions, unless the context clearly indicates otherwise. The term “microbicide”, “biocide”, “preservative” or “antimicrobial” refers to the capability of killing, inhibiting the growth of, or controlling the growth of microorganisms; microbicides include bactericides, fungicides, viricides and algicides. The term “microorganism” includes, for example, fungi (such as yeast and mold), bacteria, viruses and algae. The combination of a) and b) as described herein are antimicrobial.

Microorganisms that are affected by microbicide include, but are not limited to, Aureobasidium pullulans, Bacillus cereus, Bacillus thuringiensis, Chaetomium globosum, Enterobacter aerogines, Escherichia coli, Gliocladtum vixens, Klebsiella pneumoniae, Legionella pneumpophila, Listeria monocytogenes, Mycobacterium tuberculosis, Porphyromonas gingivalis, Proteus mirabilis, Proteus vulgaris, Pseudomonas aeruginosa, Saccharomyces cerevisiae, Salmonella gallinarum, Salmonella typhimurium, Staphylococcus aureus, Staphylococcus epidermidis, Streptococcus agalactiae, Streptococcus faecalis, Streptococcus pneumoniae, Streptococcus mutans, Trycophyton malmsten, Vibrio parahaemolyticus, Stachybotrys, Aspergillus niger, Candida albicans, Penicillium funiculosum, Methicillin-resistant Staphylococcus aureus (MRSA), Citrobacter diversus, Enterobacter cloacae, S. saprophyticus, Actinobacter spp, Enterococcus faecalis, Clostridium difficle, Bovine Viral Diarrhea Virus (Surrogate for Human Hepatitis C Virus) Source and Rhinovirus and Vancomycin-resistant enterococcus (VRE).

Food borne pathogens are also very problematic in kitchens and food working surfaces. Accordingly, the inventors envision employing the inventive combination as effective agents against cross contamination for example preventing cross contamination of Listeria spp., Campylobacter spp., Escherichi coli 0157:H7, Giardia lamblia, Salmonella spp., Staphylococcus, S. aureus and Norovirus, Vibrio spp., Shigella spp. and Yersiniosis.

The order of steps in the above claimed methods do not depend on the order. For example, the addition of component (a) and (b) to component (c) can occur in any order such as (c) can be first combined with (a) then combined with (b). Alternatively, (a) and (b) can be combined simultaneously with (c).

The coating compositions or molding compositions (formed from (a), (b), (c) and optionally (d)) will have a Tg above 30 or 50 degrees Centigrade or having a melting point of greater than about 80 degree C. More typically, the formed coating compositions or molding compositions will have a Tg above 80, 100 or 120° C. or a melting point of greater than about 80 degrees C.

Tg stands for glass transition point and is well known in the art and is the reversible transition in amorphous materials from a hard state into a molten or rubber-like state.

Antimicrobial Metal Component a)

The antimicrobial component contains an antimicrobial metal or metal oxide which metal is selected from the group consisting of zinc, copper, elemental silver for example silver nanoparticles, colloidal silver, silver compounds such as silver nitrate, silver citrate, silver sulfadiazine, silver acetate, silver sulphate, silver chloride, silver oxide, silver complexes; antimicrobial metal-containing zeolites, antimicrobial metal-containing glasses and silver-silica composites.

The antimicrobial metal-containing zeolites of component a) are those such as described in U.S. Pat. Nos. 4,775,585, 4,911,898, 4,911,899 and 6,071,542, the disclosures of which are hereby incorporated by reference.

The antimicrobial metal is preferably silver, copper, zinc or a combination of these metals. Especially preferred metals are silver or a combination of silver with copper, zinc or zirconium. Most typical are silver optionally with zinc in a glass matrix or zeolite matrix.

Although elemental metals may be used it may be more typical to use the ionic forms such as Ag⁺ and/or Zn²⁺.

In addition to zeolites, it is also contemplated that antibacterial metals such as silver, silver compounds and silver complexes may be supported on other inert materials, for example SiO₂, TiO₂ and glass. Silver compounds or silver complexes on glass or zeolite may be preferred with or without zinc.

For example composites containing silver and/or zinc such as:

Ag⁺ and Zn²⁺ in a zeolite is possible with the silver loading varying from about 0.34 to 0.54% and the zinc loading varying from about 53.0 to about 63.0%. The zeolite allows for controlled silver ion release.

Ag⁺ in glass/Zn²⁺ in zeolite where the silver content varies from about 0.9 to about 1.3% and the zinc content varies from 3.0 to 3.6%. The glass may be a magnesium-sodium-boron-phosphate glass which carries the silver, while the zinc is carried on the zeolite.

Ag⁺ and Zn²⁺ in glass is a mixture of an aluminum-boron-phosphate-glass with silver and zinc ions. The silver content varies from about 0.35 to about 0.55% and zinc content varies from about 17.0 to about 21.0%.

Ag⁺ and Zn²⁺ in zeolite which is a sodium aluminum silicate zeolite in which silver and zinc ions are incorporated is possible. The silver content is about 3.5% and the zinc content is about 7.5 wt. %.

The weight % in the above composites is based the total weight of the composite. Other exemplary silver compositions are IonPure® (Ishizuka Glass, Iwakura-shi, Japan), such as IonPure® WPA, IonPure® IZA, and IonPure® IPM. Particular embodiments include the use of glass-containing silver zeolite compositions capable of releasing silver ions. Another exemplary silver composition is ACT Z 200′ and ACT T 558′ (EnviroCare Inc., Wilmington, Mass., USA). Particular embodiments include the use of these zeolite compositions capable of releasing the silver ions.

Other silver compositions include AlphaSan® (Milliken & Company, Spartanburg, S.C.); Agion® natural zeolites (Agion Technologies, Inc., Wakefield, Mass.); Zeomic® AJ (Sinanen Zeomic Co., Tokyo, Japan); Apacider® (Sangi Co., Tokyo, Japan); silver metal coated nanospheres, fibers, or particles; and polymeric ligands.

Various combinations of these silver compositions can be used to control the silver release rate over time.

Thus the antimicrobial metal containing compounds are preferably a silver containing zeolite silver containing glasses (such as IonPure® IZA), a silver-silica composite (as found in U.S. Published Application No. 2012-0294919), a silver containing compound such as silver nitrate, silver sulfadiazine, silver acetate, silver sulphate, silver citrate, silver chloride, silver oxide and silver complexes or elemental silver, colloidal silver and silver nanoparticles.

Furthermore the antimicrobial compound is most preferably a silver ion releasing zeolite or a silver ion releasing glass and the zeolite or glass in addition to silver may contain copper or zinc.

The concentration of the amount of component (a) the antimicrobial metal component within the coating or molding composition may vary depending on the application.

However if the antimicrobial metal is in the neutral state (elemental silver for example), the weight will range from about 0.05 wt. % to about 10 wt. % or preferably about 0.1 to about 5 wt. % most preferably about 0.5 to about 3 wt. % and the basis is the total weight of polymer (c) in the composition.

If the antimicrobial metal is in the ionic state (for example Ag⁺, Zn⁺², Cu⁺¹ or Cu⁺²), the wt. % will range from about 0.005 wt. % to about 1 wt. %, preferably about 0.01 wt. % to about 0.5 wt % and most preferably about 0.05 to about 0.3 wt %. The basis is the total weight of the polymer (c) in the composition.

Preferably the antimicrobial metal is silver in the ionic form and the silver may also include a second antimicrobial metal such as zinc.

The inventive compositions (components (a), (b), (c) and optionally (d) are part of a coating composition or a molding composition. Thus the present application embraces

An antimicrobial polymeric coating composition or a polymeric molding composition comprising
(a) An antimicrobial metal, preferably wherein the antimicrobial metal of component (a) is selected from the group consisting of zinc, copper, elemental silver, colloidal silver and, silver compounds selected from group consisting of silver nitrate, silver citrate, silver sulfadiazine, silver acetate, silver sulphate, silver chloride, silver oxide, silver complexes; silver metal-containing zeolites, silver metal-containing glasses and silver-silica composites, most preferably is selected from elemental silver, colloidal silver and silver compounds selected from the group consisting of silver nitrate, silver citrate, silver sulfadiazine, silver acetate, silver sulphate, silver chloride, silver oxide, silver complexes; silver metal-containing zeolites, silver metal-containing glasses and silver-silica composites and especially ionic silver;
(b) about 0.1 to about 20, preferably 1 to 12 wt. % of a first polymer containing a monomer unit of formula (I)

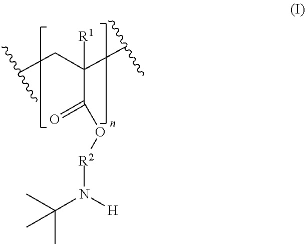

wherein R¹ is H or CH₃,
R² is C₁-C₅ alkyl bi-radical,
and
n is a number from 3 to 10,000;
(c) a second polymer which is a film-forming polymer or a thermoplastic polymer, and
(d) optionally, a quaternary ammonium compound,
   wherein the wt. % is based on the total weight of (c) and (c) is different than the first polymer of component (b).
Further the application embraces an antimicrobial polymeric coating composition or the polymeric molding composition,
wherein the antimicrobial metal
if in the neutral state (elemental silver for example), the weight will range from about 0.1 wt. % to about 10 wt. % or preferably about 0.5 to about 5 wt. % most preferably about 1 to about 3 wt. % and the basis is the total weight of polymer (c) in the composition.
if the antimicrobial metal is in the ionic state (for example Ag⁺, Zn⁺², Cu⁺¹ or Cu⁺²), the wt. % will range from about 0.005 wt. % to about 1 wt. %, preferably about 0.01 wt. % to about 0.5 wt % and the basis is the total weight of the polymer (c) in the composition.

Component b)—The First Polymer
The first polymer comprises a monomer unit of formula (I)

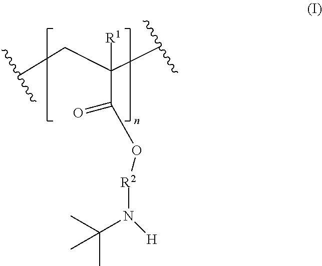

wherein R¹ is H or CH₃,
R² is C₁-C₅ alkyl bi-radical,
and
n is a number from 3 to 10,000.
Preferably,
R² is C₁-C₃ alkyl bi-radial,
and R¹ is hydrogen or methyl.
Most preferably,
R² is C₂ alkyl bi-radical,
and
R¹ is methyl.

The monomer unit formula (I) of the first polymer (b) may be protonated or unprotonated. If protonated, the first polymer will carry a positive charge. The charge on the polymer may vary depending upon the environment of the composition to which it is added. A slightly acidic environment will give rise to protonation and thus will favour a positive charge on the first polymer.

The most typical monomer forming a monomer unit of formula (I) is 2-tert-butylaminoethyl(meth)acrylate (tBAEMA).

The first polymer is a synergist, in that it appears to augment the activity of the antimicrobial metal allowing for lower effective levels within the bulk polymer either as a coating or a molding and (b) may be a copolymer or homopolymer.

The first polymer (b) containing monomer unit of formula (I) may be formed from a monomer or monomers meeting the description of formula (I) only or may be formed from the monomer unit of formula (I) and additional different monomers units.

For example, the polymer may be formed from tert-butylaminoethyl(meth)acrylate (tBAEMA) and additional cationic monomers such as for example 2-dimethylaminoethyl(meth)acrylate, 2-diethylaminoethyl(meth)acrylate, 3-dimethylaminopropyl(meth)acrylate, N-3-dimethylaminopropyl(meth)acrylamide, and N-3-diethylaminopropyl(meth)acrylamide.

Additional monomers which may be considered in are quaternized cationic monomers, amine containing monomers (other than monomers of monomer unit of formula (I)), anionic monomers such as (meth)acrylic acid and neutral monomers such a (meth)acrylate esters and olefinic/styrene and derivatives.

For example co-monomers may be selected from:

anionic monomers such as (meth)acrylic acid, maleic acid, itaconic acid and crotonic acid;

cationic monomers such as dimethylaminoethyl acrylate, diethylaminoethyl acrylate, dimethyl aminoethyl methacrylate, diethylaminoethyl methacrylate, tertiary butylaminoethyl methacrylate, N,N-dimethylaminopropyl acrylamide, N,N-dimethyl-aminopropyl methacrylamide, quarternary derivative thereof, dimethyl aminoethyl vinyl ether; 2-methyl-1-vinyl imidazole; vinyl pyridine; vinyl benzyl amine; diallyldimethylammonium chloride; trimethyl-(vinyloxyethyl)ammonium chloride; 1-vinyl-2,3-dimethylimidazolinium chloride; vinyl benzyl amine hydrochloride; diallyamine, vinyl pyridinium hydrochloride, vinyl pyrollidone, quaternized vinyl pyrollidone, vinyl imidazole, quaternized vinyl imidazole or any combination thereof and mixtures thereof;

Neutral co-monomers are also considered such as N,N-dimethyl acrylamide; N-isopropyl acrylamide; N,N-diethyl acrylamide; styrene, para-methyl styrene, chloromethyl styrene, vinyl toluene, ethylene, butadiene, methyl(meth)acrylate, ethyl(meth)acrylate, propyl(meth)acrylate, butyl(meth)acrylate, pentyl(meth)acrylate, glycidyl(meth)acrylate, monomethyl maleate, (meth)acrylonitrile, (meth)acrylamide, N-methylol(meth)acrylamide, vinyl acetate, C₃-C₈ alkyl vinylethers, C₃-C₈ alkoxy vinyl ethers, vinyl chloride, vinylidene chloride.

While the first polymer (b) comprising the monomer unit of formula (I) may be a co-polymer, it is believed that there should be significant connected monomers units of formula (I). For example, a suitable random or block copolymer of first polymer (b) can be a copolymer preferably with a mole % of monomer unit of formula (I) is about 30 mole %, about 40 mole %, about 50 mole %, about 60 mole %, about 80 mole %, about 90 mole % or about 95 mole % with the mole percent based on the total number of repeat units of the (b). Typically the mole % of the monomer unit of formula (I) is about 30 mole % to about 95 mole %, about 50 mole % to about 90 mole % or about 60 mole % to about 85 mole %, wherein the mole percent is based on the total number of monomer units of the co-polymer of (b).

Accordingly the application envisions:

An antimicrobial polymeric coating composition or the polymeric molding composition, wherein the first polymer (b) is a homopolymer and formed from tert-butylaminoethyl(meth)acrylate (tBAEMA).

And an antimicrobial polymeric coating composition or the polymeric molding composition, wherein the first polymer of component (b) is a co-polymer formed from the monomer unit of formula (I), which monomer unit of formula (I) comprises about 30 to about 98 wt. %, preferably about 40 to about 95 wt. % of the total weight of the co-polymer.

If the first polymer comprising the monomer unit of formula (I) is a co-polymer, the co-polymer may be a block co-polymer containing at least one block formed from monomer units of formula (I).

Alternatively, the first polymer could be a co-polymer and have a grafted or a brush architecture wherein the co-polymer contains pendant graft monomer repeat units of formula (I) along a linear polymer chain. Hyperbranched architectures are also envisioned wherein a central multifunctional acrylate may be polymerized with additional monomers which form monomer units of formula (I) giving a star like or hyperbranched configuration wherein the monomer repeat units of formula (I) radiate around the central multifunctional acrylate.

Therefore, the first polymer (b) may have most any architecture and can be a linear polymer formed from several different monomer(s) to give different monomer units along with the monomer unit of formula (I).

The first polymer may be water soluble or water insoluble. Preferably, however, the first polymer is substantially water-insoluble.

Water-insoluble for purposes of this application means<5%, preferably <1% soluble in deionized water at room temperature (25° C.) and pressure.

The term substantially “water-insoluble” for purposes of this application means that less than 5 wt. %, preferably less than 3 wt. %, most preferably less than 1 wt. % and especially 0.5 or 0.1 wt. %, most especially <100 ppm or <10 ppm of the first polymer is soluble in deionized water at room temperature (25° C.) and pressure. For example, the first polymer according to formula (II) may be <10 ppm soluble in deionized water at room temperature.

The concentration of the amount of component (b) the first polymer (the synergist) in the composition may vary depending on the application.

But normally, the total weight of the first polymer will range from about 0.1-20 wt. %, preferably 1-12 wt. %, most preferably about 1 to 10 or to about 9 wt. % based on the total weight of polymer (c).

The first polymer (b) has a weight average molecular weight ranging from about 500 to 10,000,000 g/mole, preferably from about 1000 to about 500,000 g/mole, more preferably about 1000 to about 250,000 g/mole, most preferably about 500 to about 100,000 g/mole and especially about 500 g/mole to about 30,000 g/mole.

Even more typically the first polymer (b) is a low weight average molecular weight (MW<50, 000) with a narrow MW distribution (polydispersity Mw/Mn<4). For example, the first polymer (b) is a homopolymer may have a Mw ranging from about 500 g/mole to about 30,000 g/mole or about 500 g/mole to about 25,000 g/mole.

The average molecular weights of polymers formed from formula (I) are measured by gel permeation chromatography (GPC) using poly(methyl methacrylate) narrow molecular weight standards.

The polymers can be employed as salts. In general any counterion may be employed, including, for example, halides, organic carboxylates, organic sulfonic acid anions and the like.

### Preparation of the First Polymer of Component (b)

The alkylaminoalkyl(meth)acrylate polymers of repeat unit n can be prepared by virtually any conventional random radical polymerization, controlled radical polymerization (CRP), anionic polymerization and cationic polymerization with reaction conditions aimed for virtually any molecular weight polymers known to the art skilled. The preparation can be carried out using various polymerization techniques such as solution, emulsion, microemulsion, inverse emulsion, and/or bulk polymerizations, as well as other technologies that are available to those who are skilled in the art.

Molecular weights of polymers synthesized by radical polymerization, anionic polymerization and cationic polymerization can be controlled by varying reaction conditions such as initiator type and concentration, monomer concentration, reaction temperature, chain transfer agent type and concentration. Generally, high concentration of initiator, low concentration of monomer, high reaction temperature and addition of a chain transfer agent are used to achieve low molecular weights for the first polymers.

Conventional random radical polymerization provides a simple way to make the first polymer. The source of free radicals required to initiate the polymerization of the radically polymerizable monomers is a free radical initiator. The free radicals may be formed by thermal or photoinduced decomposition of the initiator or by a redox reaction with the initiator.

Typical free radical initiators include, but not limited to, azo and peroxide compounds. Typical azo initiator include azobis(isobutyronitrile) (AIBN), dimethyl 2,2′-azobisisobutyrate (MAIB), 1,1′-azobis(1-cylcohexanenitrile), 2,2′-azobis(2,4,4-trimethylpentane), and azobis-2,4-dimethylvaleronitrile, polymeric or oligomeric materials comprising azo, —N═N—, groups. Water soluble azo initiator may be used in emulsion polymerization and selected from the group consisting of 2,2-azobis-(N,N′-dimethylene-isobutyramidine)dihydrochloride, 2,2′-azobis-(2-amidinopropane)dihydrochloride, 4,4′-azobis-(4-cyanopentane-carboxylic acid); 2,2′-Azobis[2-(5-methyl-2-imidazolin-2-yl)propane]dihydrochloride; 2,2′-Azobis[N-(2-carboxyethyl)-2-methylpropionamidine]tetrahydrate; 2,2′-Azobis[2-(3,4,5,6-tetrahydropyrimidin-2-yl)propane]dihydrochloride; and 2,2′-Azobis{2-methyl-N-[2-(1-hydroxybuthyl)]propionamide.

Typical peroxide radical initiator may include acyl and diacyl peroxides, alkyl peroxides, dialkyl peroxydicarbonates, hydroperoxides such as tert.-butylhydroperoxide, peresters, and inorganic peroxides such as hydrogen peroxide, ammonium persulfate, potassium persulfate and sodium persulfate, benzoyl peroxide (BPO) or a peroxy acid such as peroxyacetic acid or peroxybenzoic acid. The redox initiator in combination with reducing agents is selected from the group consisting of, for example, an acyl peroxides with tertairyamine such as triethylamine, and tert.-butylhydroperoxide or persulfate with iron(II)-ammonium sulfate, ascorbic acid, sodium methyl sulfinate, disodium disulfite, sodium hydrogen sulfite, sodium phosphite, potassium phosphate, hydrogen phosphite, sodium hypophosphite or potassium hypophosphite.

Azo initiator such as AIBN may be used at high concentration from 1% to 20% based on monomer to achieve low molecular weight using radical polymerization to prepare the first polymer low molecular weight polymers. Lower concentration of initiator may be used in combination with an effective chain transfer agent to obtain low molecular weight.

Suitable chain transfer agents may include mercaptans such as dodecyl mercaptan, octyl mercaptan, hexyl mercaptan and ethanolmercaptan and halogen-containing compounds such as carbon tetrabromide.

However, controlled living polymerization methods may also be used for preparing the first polymer component (b). Living polymerization techniques have been traditionally used for the synthesis of well-defined polymers where polymerization proceeds in the absence of irreversible chain transfer and chain termination, i.e. nearly ideally in anionic polymerization and less ideally in cationic polymerization. Anionic living polymerization is initiated by nucleophilic addition to the double bond of the monomer using an organo-metallic initiator such as an alkyl lithium or Grignard reagent. An alternative means of initiation is electron transfer which occurs when alkali metals or similar species are the initiators. Cationic polymerization, on the other hand, is initiated by electrophilic agents such as a protonic acid and a Lewis acid. Examples of Lewis acid initiators include AlCl₃, SnCl₄, BF₃, TiCl₄, AgClO₄, and I₂ in combination with a co-initiator such as H₂O or an organic halogen compound.

Although most of the ionic living polymerization techniques are not tolerant towards primary and secondary amino functional groups in the monomers to be polymerized, anionic polymerization of t-butylaminoethyl methacrylate is possible because of its relatively low basicity. Tertiary butyl amino ethyl methacrylic polymers can be prepared by anionic polymerization method described in “Living anionic homo- and block copolymerization of 2-(tert-butylamino)ethyl methacrylate” by Serge Creutz, Philippe Teyssie and Robert Jerome, J. Polymer Science (part A), vol 35 (10), 1997, 2035-2040 using a monomer to initiator molar ratio of from 5 to 100. Preferred initiators are diphenylmethyllithium with lithium chloride.

Typical controlled radical polymerization is provided by recent methods such as atom transfer radical polymerization (ATRP), nitroxide-mediated radical polymerization (NMP), reversible addition-fragmentation chain transfer polymerization (RAFT) and other related processes involving a degenerative transfer, such as macromolecular design via interchange of xanthates (hereinafter referred as MADIX).

Weight Ratio of (a) (Antimicrobial Metal) to (b) (First Polymer)

If the antimicrobial metal is in ionic from the weight ratio of (b) to (a) will range from about 100 to about 1, preferably from about 50 to 1 and most preferably 25 to 35 to 1. Ranges of 20 to 1 or 10 to 1 are also effective.

If the antimicrobial metal is in the neutral form, the weight ratio of (b) to (a) will range from about 100 to about 10, or most preferably from about 50 to about 10. Normally the neutral form of the metal, preferably silver, requires about 10 times the ionic form of the metal, preferably silver.

Accordingly the antimicrobial polymeric coating composition or the polymeric molding composition, wherein
if the antimicrobial metal (a) is in ionic state the weight ratio of (b) to (a) will range from about 100 to about 1, preferably from about 50 to about 1 and most preferably about 30 to about 1, and
if the antimicrobial metal (a) is in the neutral form, the weight ratio of (b) to (a) will range from 100 to 10, or most preferably from 50 to 10 or especially 30 to 10.
If the antimicrobial metal (a) is in the ionic state the wt. ratio of (b) to (a) may also range from 10-111(b) to 1(a), preferably from 15-50(b) to 1(a) and most preferably 20-35(b) to 1(a).

The Component (c)

Component (c) Polymers

The film forming polymers or thermoplastic polymers embraced by component (c) would include:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE), linear low density polyethylene (LLDPE), branched low density polyethylene (BLDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).

b) catalytic polymersation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either .pi.- or .sigma.-coordinated. These metal complexes may be in the free form or fixed on substrates, typically on activated magnesium chloride, titanium(II) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C.sub.5-C.sub.9) including hydrogenated modifications thereof (e.g. tackifiers) and mixtures of polyalkylenes and starch.

5. Polystyrene, poly(p-methylstyrene), poly(.alpha.-methylstyrene).

6. Copolymers of styrene or .alpha.-methylstyrene with dienes or acrylic derivatives, for example styrene/butadiene, styrene/acrylonitrile, styrene/alkyl methacrylate, styrene/butadiene/alkyl acrylate, styrene/butadiene/alkyl methacrylate, styrene/maleic anhydride, styrene/-acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

7. Graft copolymers of styrene or .alpha.-methylstyrene, for example styrene on polybutadiene, styrene on polybutadienestyrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from .alpha., .beta.-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylatelbutadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers or polyether polyols.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate and polyhydroxybenzoates, as well as block copolyether esters derived from hydroxy-terminated polyethers; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and nondrying alkyd resins.

23. Unsaturated polyester resins derived from copolyesters of saturated and unsaturated dicarboxylic acids with polyhydric alcohols and vinyl compounds as crosslinking agents, and also halogen-containing modifications thereof of low flammability.

24. Crosslinkable acrylic resins derived from substituted acrylates, for example epoxy acrylates, urethane acrylates or polyester acrylates.

25. Crosslinkable alkyd resins, polyester resins, polyether resins and acrylate resins crosslinked with melamine resins, urea resins, polyisocyanates or epoxy resins.

26. Crosslinked epoxy resins derived from polyepoxides, for example from bisglycidyl ethers or from cycloaliphatic diepoxides.

27. Crosslinked dihydrazides, aldehydes, acetoacetic esters.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

32. Polysiloxanes such as the soft, hydrophilic polysiloxanes described, for example, in U.S. Pat. No. 4,259,467; and the hard polyorganosiloxanes described, for example, in U.S. Pat. No. 4,355,147.

33. Polyketimines in combination with unsaturated acrylic polyacetoacetate resins or with unsaturated acrylic resins. The unsaturated acrylic resins include the urethane acrylates, polyether acrylates, vinyl or acryl copolymers with pendant unsaturated groups and the acrylated melamines. The polyketimines are prepared from polyamines and ketones in the presence of an acid catalyst.

34. Radiation curable compositions containing ethylenically unsaturated monomers or oligomers and a polyunsaturated aliphatic oligomer.

35. Epoxymelamine resins such as light-stable epoxy resins crosslinked by an epoxy functional coetherified high solids melamine resin such as LSE-4103 (Monsanto).

36. Polyethyleneimines (PEI).

Silicone Rubber

For purposes of the invention the term “silicone rubber” means a cured silicone.

The term “silicone” for purposes of the invention means a uncurred silicone such as a liquid or high consistency (gum-like) silicone resin before curing.

Silicone rubber is an especially important material for bio-medical applications. Accordingly, one of the objectives of the present invention is to provide a method of incorporating or coating a first polymer of monomer unit of formula (I) and an antimicrobial metal into a silicone resin, especially a Liquid Silicone Rubber (LSR) or high consistency (gum) silicone rubber and then curing.

Silicone rubber is most commonly fabricated by compression, extrusion or injection means of a catalyzed formulated gum or liquid silicone compositions. Further, the silicone rubber may bonded to surfaces such as metals, plastics etc.

Foamed or sponge silicone rubber can be made by incorporating chemical blowing agents into the rubber stock, which typically eliminate nitrogen or carbon dioxide under the thermal curing conditions.

An increasingly important processing technique for silicone rubber is liquid injection molding (LIM). These materials are also referred to as liquid silicone rubber (LSR) and these are compositions of interest in regard to the present application.

There are a number of advantages of liquid injection molding such as rapid cycle times and the ability to fill complex mold shapes because of the low viscosity of the starting material. LIM is ideal for Silicone LIM rubber and is generally comprised a two-component polymer system. One part (Part B) contains a linear polydimethylsiloxane polymer with pendent Si H functionality, reinforcing fillers such as fumed silica, extending fillers, pigments, and stabilizers. The second part (Part A) contains linear PDMS with terminal and pendent vinyl groups; reinforcing and extending fillers; a platinum hydrosilylation catalyst; and a catalyst inhibitor, commonly olefins, alkynes, amines, or phosphines. Incorporation of trifluoropropylsilyl groups is possible if solvent resistance is desired.

After the parts are mixed and heated, the catalyst initiates the cross-linking reaction by addition of the Si H group to the double bond. Latent cure catalysts have been developed that allow the formulation of one-component products. These systems work by incorporation of platinum ligands that deactivate the platinum hydrosilylation catalysts at room temperature. When heated to temperatures above 100° C., these catalysts become active. Please see But, M. et al., 2003, Silicones, Encyclopedia of Polymer Science and Technology.

The two part LSR of different compositions individually have long enough shelf-life and are stable and remain liquid until they are mixed together. When the two packages of the liquid silicone materials are mixed together, crosslinking takes place and the mixture will cure and form solid elastomeric material at an appropriate temperature.

Furthermore, the present invention is also concerned with the use of high consistency silicone rubber compositions. These compositions differ from the liquid silicone rubber compositions in that they are not liquids but gums and are generally preferred for such applications as rubber tubing and the like.

Thus the present invention is preferably concerned with a silicone rubber comprising the monomer units off formula (I) and the antimicrobial metal described above in or on a liquid or gum like silicone rubber and curing to form the fabricated, molded or extruded composition.

Accordingly the silicone rubber composition according the invention is preferably one in which the silicone rubber is cured to form a cured silicone rubber and components a) and b) are added to the silicone rubber before curing or alternatively the components a) and b) are part of a coating on the silicone rubber.

The additives (b) and the inorganic metals described above, additive (a) are preferably added directly into the liquid or gum-like silicone rubber and then cured to form a solid article or product.

Film-Forming Polymer of (c)

Typically a coating is formed from a film-forming polymer. For purposes of this application the term “binder polymer” may be synonymous with “film-forming” polymer, a polymer typically encountered as part of a coating system or paint, such as coatings for automobiles, appliances, wood, plastic articles, paper, glass etc.

Typically film-forming polymer can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin, predominantly on a thermosetting resin. Examples thereof are alkyd, acrylic, acrylamide, polyester, styrenic, phenolic, melamine, epoxy and polyurethane resins.

For example, non-limiting examples of common coating film-forming polymers useful in the present invention include silicon containing polymers, fluorinated polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The film-forming polymers may be copolymers, polymer blends or composites.

Film-forming polymers are frequently crosslinked with, for example, melamine resins, urea resins, isocyanates, isocyanurates, polyisocyanates, epoxy resins, anhydrides, poly acids and amines, with or without accelerators.

The film-forming polymer or binder can be a cold-curable or hot-curable binder; the addition of a curing catalyst may be advantageous. Suitable catalysts which accelerate curing of the binder are described, for example, in Ullmann's Encyclopedia of Industrial Chemistry, Vol. A18, p. 469, VCH Verlagsgesellschaft, Weinheim 1991.

The film-forming polymer may be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The film-forming polymer or binder may also be a mixture of different surface coating resins. Provided the binders are curable binders, they are normally used together with a hardener and/or accelerator.

Examples of coating compositions containing specific film-forming polymer are:
1. coatings based on cold- or hot-crosslinkable alkyd, acrylate, polyester, epoxy or melamine resins or mixtures of such resins, if desired with addition of a curing catalyst;
2. two-component polyurethane coatings based on hydroxyl-containing acrylate, polyester or polyether resins and aliphatic or aromatic isocyanates, isocyanurates or polyisocyanates;
3. one-component polyurethane coatings based on blocked isocyanates, isocyanurates or polyisocyanates which are deblocked during baking, if desired with addition of a melamine resin;
4. one-component polyurethane coatings based on a Trisalkoxycarbonyltriazine crosslinker and a hydroxyl group containing resin such as acrylate, polyester or polyether resins;
5. one-component polyurethane coatings based on aliphatic or aromatic urethaneacrylates or polyurethaneacrylates having free amino groups within the urethane structure and melamine resins or polyether resins, if necessary with curing catalyst;
6. two-component coatings based on (poly)ketimines and aliphatic or aromatic isocyanates, isocyanurates or polyisocyanates;
7. two-component coatings based on (poly)ketimines and an unsaturated acrylate resin or a polyacetoacetate resin or a methacrylamidoglycolate methyl ester;
8. two-component coatings based on carboxyl- or amino-containing polyacrylates and polyepoxides;
9. two-component coatings based on acrylate resins containing anhydride groups and on a polyhydroxy or polyamino component;
10. two-component coatings based on acrylate-containing anhydrides and polyepoxides;
11. two-component coatings based on (poly)oxazolines and acrylate resins containing anhydride groups, or unsaturated acrylate resins, or aliphatic or aromatic isocyanates, isocyanurates or polyisocyanates;
12. two-component coatings based on unsaturated polyacrylates and polymalonates;
13. thermoplastic polyacrylate coatings based on thermoplastic acrylate resins or externally crosslinking acrylate resins in combination with etherified melamine resins;
14. paint systems based on siloxane-modified or fluorine-modified acrylate resins.

The coating composition can also comprise further components, examples being solvents, pigments, dyes, plasticizers, stabilizers, thixotropic agents, drying catalysts and/or levelling agents. Examples of possible components are those described in Ullmann's Encyclopedia of Industrial Chemistry, 5th Edition, Vol. A18, pp. 429-471, VCH, Weinheim 1991.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds, for example.

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzylammonium chloride.

Amino-containing resins are simultaneously binder and curing catalyst. Examples thereof are amino-containing acrylate copolymers.

The curing catalyst used can also be a phosphine, for example triphenylphosphine.

The coating compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453. In radiation-curable coating compositions, the novel stabilizers can also be employed without the addition of sterically hindered amines.

The coating may also be a radiation-curable, solvent-free formulation of photopolymerisable compounds. Illustrative examples are mixtures of acrylates or methacrylates, unsaturated polyester/styrene mixtures or mixtures of other ethylenically unsaturated monomers or oligomers.

The coating compositions can comprise an organic solvent or solvent mixture in which the binder is soluble. The coating composition can otherwise be an aqueous solution or dispersion. The vehicle can also be a mixture of organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

The film-forming polymer is, for example, selected from acrylate, acrylamide polyether, polyester, polyamide, polyurethane, polyolefine, polyvinyl alcohol, epoxy and fluoro polymer resins including co-polymeric resins, for example, acrylates, polyethers, polyesters and polyvinyl alcohols, for example, acrylates, polyethers and polyesters, including crosslinked polymers such as crosslinked systems comprising any of the preceding resins, for example any of the preceding resins crosslinked with melamine, an isocyante, an aldehyde, alderhyde equivalent or polyaldehyde, a polyalcohol, polyamine or polyalcohol or polyamine functionalized with acrylic acid or methacrylic acid, an isocyante, for example an acrylate, polyether or polyester crosslinked with melamine or an isocyanate.

In one embodiment, the film-forming polymer is part of a water born coating, that is a polymer that is water soluble or present in water as a latex or dispersion. For example, a polyacrylate, polyacrylamide, polyester or polyvinyl alcohol solution, latex or dispersion, for example, a polyacrylate, polyacrylamide or polyester solution, latex or dispersion, for example, a polyacrylate solution or dispersion.

The different film-forming polymers may be combined with (a), (b) and optionally (d) using any standard processing steps for polymer resins and coating formulations. For example, the film-forming polymer and (a) and (b) may be dry blended or dissolved in a solvent or solvents. In one embodiment, water or an aqueous mixture is the solvent. A solution or dispersion of one polymer may be mixed with a solution or dispersion of another, or one polymer as a single component may be blended with a solution or dispersion of another polymer.

It is also possible to further process the film-forming polymer by blending techniques common in thermoplastic processing such as extrusion, compression molding, Brabender melt processing, other molding and film forming processes etc.

Typically however, the blending of (a), (b) and (c) (either a film-forming polymer or thermoplastic) will be done using techniques practiced in coatings technology, for example, the preparation of a coating formulation that comprises a solution or dispersion of the film-forming polymer or thermoplastic in a solvent which is then applied to the appropriate substrate, for example, the surface of the substrate via spraying, spin coating, drop coating, drawdown, brushing, dipping or any other standard coating application technique.

If crosslinking of the film-forming polymer is desired, the crosslinking can take place at any point in the process, for example, an already crosslinked polymer may be used in the initial dispersion or in preparing the coating formulation, or the polymer may be crosslinked after application of the coating formulation.

Drying or curing the coating formulation after application to the substrate can be accomplished by any standard means appropriate to the formulation components, for example, simply allowing the applied formulation sit at room temperature under standard environmental conditions, heating may be applied, reduced pressure may be used, exposing the formulation to electrochemical radiation, application of a further curing agent or catalyst etc.

More than one film-forming polymer may be present in the thus formed coating composition of the invention.

The component (c) a film-forming polymer or a thermoplastic polymer makes up about 80, 90 or at least 95 wt. % of the total weight of the polymeric portion of the coating composition or the molding composition.

For example, the component (c) the film-forming polymer or the thermoplastic polymer will typically comprise at least about 95 wt. %, preferably about 98 wt. % of the polymeric coating composition solids or the polymeric molding composition solids. The weight % basis of (c) is the total weight of the solids of the polymeric coating composition or the polymeric molding composition.

The coating may be applied to a surface which has already been coated, such as a protective coating, a clear coat or a protective wax applied over a previously coated article. The coating composition is applied to a surface by any conventional means including spin coating, dip coating, spray coating, draw down, or by brush, roller or other applicator. A drying or curing period will typically be needed.

Coating systems include marine coatings, wood coatings, other coatings for metals and coatings over plastics and ceramics. Exemplary of marine coatings are gel coats comprising an unsaturated polyester, a styrene and a catalyst.

The coating is, for example a house paint, or other decorative or protective paint. It may be a paint or other coating that is applied to cement, concrete or other masonry article. The coating may be a water proofer as for a basement or foundation.

Coating or film thickness will vary depending on application and will become apparent to one skilled in the art after limited testing.

The composition may be in the form of a protective laminate film.

Such a film typically comprises thermoset, thermoplastic, elastomeric, or crosslinked polymers. Examples of such polymers include, but are not limited to, polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, fluorinated polymers, silicon containing and carbamate polymers. The polymers may also be blends and copolymers of the preceding chemistries.

A plastic film may also be applied with heat which includes calendaring, melt applications and shrink wrapping.

Typical coating components familiar to those versed in coating formulation technology such as flow aids, catalysts, wetting aids, pigments, rheology control agents, dyes, solvents, reactive diluents, adhesion promoters and stabilizers such antioxidants and light stabilizers.

In general, the coating compositions of the present application may further include from about 0.01 to about 5% by weight of the coating composition stabilizers including antioxidant, light stabilizers, UV absorbers, process stabilizers etc. mentioned below, although this will vary with the particular substrate and application. An advantageous range is from about 0.05 to about 3%, and especially 0.05 to about 1%.

Coatings of special interest are:

The coating compositions, wherein (c) is a film forming polymer

selected from the group consisting of acrylic resin lacquers such as conventional acrylic resin stoving, lacquers or thermosetting resins including acrylic/melamine systems, polyester lacquers, alkyd resin lacquers, lacquers based on alkyd/melamine resins, alkyd/acrylic/melamine resins, acid-catalyzed baked finishes, non-acid catalyzed thermoset resins such as epoxy, epoxy-polyester, vinyl, alkyd, acrylic and polyester resins, optionally modified with silicon, isocyanates or isocyanurates, UV-cured coating systems using unsaturated acrylic resins, polyurethane acrylates, epoxy acrylates, polyester acrylates, unsaturated polyester/styrene resins, vinyl ethers and styrenes and silyl acrylates.

Component (d)

Of particular interest in this application for optional component (d) as a possible additive to the coating compositions or molding compositions are the incorporation of additional antimicrobials (component d) such as quaternary ammonium compounds.

For example the quaternary ammonium compounds are of the general formula (II)

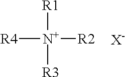

wherein R₁, R₂, R₃ and R₄ are independent of each other C₁₋₄₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups or any two of adjacent R₁, R₂, R₃, R₄ may form a five or six membered nitrogen containing ring which may be saturated or unsaturated, and

X⁻ is a halide, hydroxide, phosphate, phosphonate, carbonate, sulfate or carboxylate anion,

It is preferably that at least one of R₁, R₂, R₃ or R₄ is a C₆-C₄₀ branched or unbranched alkyl, more preferably C₆-C₃₀ alkyl unbranched.

C₁₀-C₄₀ is preferably C₁-C₂₀ alkyl (as well as, for example C₆-C₂₀—, C₁₀-C₂₀—, C₁₀-C₁₈— C₁-C₁₂—, C₁-C₈—, C₁-C₆— or C₁-C₄alkyl) is a branched or unbranched alkyl chain containing the that number of carbon atoms, which include for example, methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, isopropyl, isobutyl, tert-butyl, isopentyl, neopentyl, 2-ethylhexyl, iso-octyl, tert octyl and the like.

Likewise, alkoxy, such as C₁-C₂₀—, C₁-C₁₂-, C₁-C₁₀-, C₁-C₈-, C₁-C₆— or C₁-C₄-alkoxy is a branched or unbranched alkyl chain containing the specified number of carbons which are connected to the rest of the compounds through an oxygen atom and includes for example, methoxy, ethoxy, propoxy, isopropoxy, n-butyloxy, sec-butyloxy, iso-butyloxy, tert-butyloxy, pentyloxy, hexyloxy, heptyloxy, 2,4,4-trimethylpentyloxy, 2-ethylhexyloxy, octyloxy, nonyloxy, decyloxy or dodecyloxy, for example, methoxy, ethoxy, propoxy, isopropoxy, n-butyloxy, sec-butyloxy, iso-butyloxy, tert-butyloxy.

C₇₋₁₅ aralkyl is for example benzyl, phenethyl, phenylpropyl, cumyl, napthylmethyl, napthylethyl, napthylpropyl and the like.

The cationic antimicrobials can be selected from mono-long-chain, tri-short-chain tetraalkyl ammonium compounds; di-long-chain, di-short-chain tetraalkyl ammonium compounds; trialkyl, mono-benzyl ammonium compounds, and mixtures thereof. By “long” chain is meant alkyl of 6 or more carbon atoms. By “short” chain is meant alkyl of 5 or fewer carbon atoms. Typically, at least one of the groups R₁, R₂, R₃ and R₄ is a long chain alkyl or an alkyl interrupted by oxygen or a benzyl group.

Preferably at least one of R₁, R₂, R₃ and R₄ is an alkyl group of 6 or more carbon atoms, a benzyl group or the alkyl group is interrupted by oxygen.

Most preferably at least one of the groups R₁, R₂, R₃ and R₄ is an C₆-C₂₀ alkyl, a benzyl group, at least two of R₁, R₂, R₃ and R₄ form a nitrogen five or six membered ring or a C₆-C₄₀ alkyl interrupted by oxygen.

What is meant by a C₆-C₄₀ alkyl interrupted by oxygen are repeat units such as —CH₂—CH₂—O—, —CH₂—CH(CH₃)—O—, and —CH(CH₃)—CH₂—O—, preferably —CH₂—CH₂—O—.

Specific examples of monomeric quaternary ammonium salts that are suitable for use in the present invention include, without limitation, tetraalkylammonium salts, trialkylarylammonium salts, dialkyldiarylammonium salts, alkyltriarylammonium salts, tetraarylammonium salts, cyclic ammonium salts and dicyclic ammonium salts.

Quaternary ammonium chlorides for example which are suitable for use in the present invention include, for example, dimethyl-didodecylammonium chloride, trimethyldodecylammonium chloride, dimethyldioctadecylammonium chloride, trimethyloctadecylammonium chloride, dodecyldimethyl-benzylammonium chloride, octadecyldimethylbenzylammonium chloride, trimethylcocoammonium chloride, di-methylditallowammonium chloride, trimethylsoyammonium chloride, methyldibutylbenzylammonium chloride, methyldihexylbenzylammonium chloride, methyldioctylbenzylammonium chloride, methyldihexadecylbenzylammonium chloride, methylethyldidodecylammonium chloride, methylhexadecylpyridinium chloride, trimethyldodecyloxyphenylammonium chloride, dimethyldodecylmethylallylammonium chloride, phenyldialkyloctadecylammonium chloride, dimethylchlorobenzyloctylammonium chloride, dimethylheptadecyl-B-naphthylammonium chloride, N-stearamidomethyl-N-ethoxymethyl-N-dimethylammonium chloride, N-geranyl-N-dodecylpiperidinium chloride, N—N-dimethylpyrrolidinium chloride, and methylalkylpolyoxyalkyleneammonium chloride.

Also suitable for use in the present invention are quaternary ammonium bromides, such as tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide and N-methylpyridinium bromide.

A particular class of quaternary ammonium compounds are those of formula (III) below.

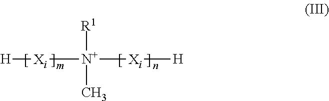

in which

R¹ is a straight-chain or branched alkyl radical, alkenyl radical, or alkadienyl radical having 6 to 30 carbon atoms,

m and n independently of one another are an integer from 1 to 20, preferably 1 to 10, more preferably 1 to 8, and more particularly 2 to 6,
and

each Xᵢ for i=1 to m and 1 to n independently of one another is selected from the group consisting of —CH₂—CH₂—O—, —CH₂—CH(CH₃)—O—, and —CH(CH₃)—CH₂—O—, preferably —CH₂—CH₂—O—.

In particular quaternary ammonium compound of the structure below is of interest.

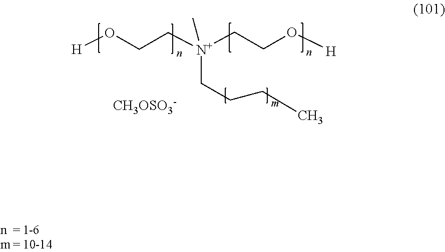

The antimicrobial polymer coating composition or polymeric molding composition may include about 0.1 to about 30 wt. %, preferably 0.5 to about 20 wt. % and most preferably about 1 to about 18 wt. % component (d) of formula (II), (III) or (101).

Fungicides may also be combined with the inventive combination. In this aspect, suitable fungicides that are applicable to this disclosure include, but are not limited to, azoles, quaternary ammonium compounds, dithiocarbamates, dicarboximides, or any combination thereof. For example, in this aspect, an azole fungicide can be selected from azaconazole, biternatol, bromuconazole, cyproconazole, diniconazole, fenbuconazole, flusilazole, flutnafol, imazalil, imibenconazole, metconazole, paclobutrazol, perfuazoate, penconazole, simeconazole, triadimefon, triadimenol, uniconazole, or any combination thereof. Also in this aspect, a dithiocarbamate fungicide can be selected from mancozeb, maneb, metiram, zineb, or any combination thereof.

Medical Devices

Other preferred plastics or polymers for biomaterials are selected from the group consisting of polysiloxane, silicon rubber, polyolefins, polyvinylchloride, polymethylmethacrylate, polyesters, polytetrafluoroethylene, polyamides, natural rubbers, polyacetal, polysulfones, polyurethanes, thermoplastic polyurethanes (TPU), polyethers, styrene/acrylic resins and polycarbonates.

Most preferred plastics or polymers for biomaterials are selected from the group consisting of thermoplastic urethanes (TPU), silicone rubbers, polyamides and styrene/acrylic resins.

Commercial examples of the above polymer would include Elastollan® 1190A, polyether containing urethane (TPU), Ultramid® B3EG5 (polyamide) and Zylar 960 (styrene/acrylic resin).

The component a), for example HyGentic® 6000, HyGentic® 8000 or Ionpure IZA and the first polymer are melt blended into Elastollan® 1190A, polyether containing urethane (TPU), Ultramid® B3EG5 (polyamide) and Zylar® 960 (styrene/acrylic resin).

Thus the polymeric coating composition or polymeric molding composition is for example part of a medical device and the device comprises (a), (b), (c) and optionally (d):
a) an antimicrobial metal component comprising at least a silver, zinc, copper, preferably silver and/or zinc,
b) about 0.1 to about 20, preferably about 0.1 to about 12 wt. % of a first polymer containing a monomer unit of formula (I)

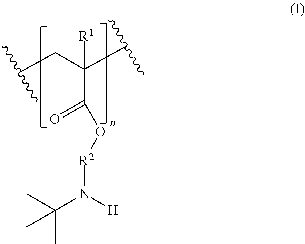

wherein R¹ is H or CH₃,
R² is C₁-C₅ alkyl bi-radical,
and
n is a number from 3 to 10,000;
c) a film forming polymer or a thermoplastic polymer is selected from the group consisting of polysiloxane, silicon rubber, polyolefins, polyvinylchloride, polymethylmethacrylate, polyesters, polytetrafluoroethylene, polyamides, natural rubbers, polyacetal, polysulfones, polyurethanes, thermoplastic polyurethanes (TPU), polyethers, styrene/acrylic resins and polycarbonates.
   and
   optionally (d) a quaternary ammonium compound.

The compositions of present invention are for example a coating applied to a surface which is exposed to conditions favorable for bioaccumulation or microbial growth. The presence of the antimicrobial compounds of components (a) (b) (c) and optionally (d) in said coating will prevent microbial growth on the surface of the coating.

Masterbatches

It is further possible to prepare polymer concentrates or masterbatches of components (a), (b) and optionally (d) and combine with (c). This is possible by combining the components (a), (b) and optionally (d) with a suitable polymer (component c) under melt conditions in a heatable container such as a kneader, mixer or extruder.

For example, an antimicrobial metal (a), preferably silver, especially ionic silver in combination with (b) preferably a homopolymer of tBAEMA and (c) a thermoplastic polymer,

wherein the wt. ratio of (b) to (a) is about 40 to 1, preferably about 35 to 25 to 1 and (c) is a thermoplastic polymer and (c) makes up about 10 to about 99 wt. %, preferably 20 to 95 wt. % and the wt. % is based on the total weight of the masterbatch.

The masterbatch is usually diluted in a polymer composition to form a shape (film, rotomolding, fiber, sheet, bottle etc.) in which the final concentration of (a) ranges from about 0.01 to about 0.3 wt. % the antimicrobial metal, preferably silver, especially ionic silver and about 0.25 to about 25 wt. % (b) with the wt. % is based on the total weight of the polymer or polymer in the composition.

A masterbatch concentrates of (a), (b) and optionally (d) can then easily be incorporated into plastic injection molded articles and synthetic fibers for example.

The anti-microbial compounds of the present invention may be part of a complete coating or paint formulation, such as a marine gel-coat, shellac, varnish, lacquer or paint, or the anti-fouling composition may comprise only components a), b) and c) of the instant invention and a carrier substance. It is anticipated that other additives encountered in such coating formulations or applications will find optional use in the present applications as well.

Applications

Articles of Manufacture (Polymeric Molding Compositions)

Molding compositions would include any shaped article such as a film, fiber, nonwoven, sheet, extruded, rotomolded or blow molded shaped polymer.

Articles or products of manufacture are for example plastic and/or rubber items such as tool handles, tool grips, toys, or other articles; machinery housing such as for computers, display and diagnostic devices or instrumentation; medical devices such as catheters, balloons, tubing, syringes, diagnostic kits, and the like; tile adhesives; kitchen items; components of sanitary equipment; components of water systems; operator units of devices such as touch panels; materials used in bathrooms such as shower curtains, fixtures, toilet items, and even jointing or sealing compounds; medical instruments, and other medical devices for providing the sustained action of bioactive agents; articles which are contacted by large numbers of people such as telephone handsets, stair rails, door handles, window catches, grab straps and grab handles in public conveyances, and the like; tabs used in adhering medical devices such as sensors, electrodes, ostomy appliances, or the like; liquid and air filters for HVAC or vacuum cleaners, or automotive uses; medical surgical gowns, drapes, dressings, covers, and the like;

Coating Applications

Examples of coating applications would for example include floor coatings for use in hospitals, clean rooms, clinics, schools, and related environments; coatings for hospital and medical environments; ceiling tiles; glass fiber coatings such as glass mats, insulation, filter materials, reinforced composites, and such; coatings for air conditioning or refrigeration coils; other components for air conditioning systems, heat exchangers, ion exchangers, process water systems including cooling water treatment, solar-powered units, coated pipes, and the like; hygiene coatings of surfaces other than floors, such as in hospitals, clinics, schools, homes, offices, and the like; hard and porous surface coatings as applicable to walls, ceilings, floors, counter tops, and the like; hygiene coatings such as used in table tops, counter tops, door knobs, door handles, fixtures, and the like; medical devices such as use in coatings for stents, implants, prostheses, catheters, tubing, contact lenses, contact lens cleaners or storage solutions, protective or backing films, medical instruments, and other medical devices for providing the sustained action of bioactive agents.

Biomaterials and Hospital Equipment/Environs

In particular, the articles of manufacture or the coating applications of most interest are those which are especially important in hospital environs and the medical device area. For example, biomaterials such as plastics for biomedical devices to impart antimicrobial and anti-biofilm forming properties on surface. Examples of biomaterials for medical devices are silicone rubbers used for catheters, polyolefins such as polyethelene (PE) used for pharmaceutical bottles, catheter, nonwoven fabric, pouch, and orthopedic implants, and polypropylene (PP) used for disposable syringes, blood oxygenator membrane, suture, nonwoven fabric, and artificial vascular grafts, polyvinylchloride (PVC) used for blood and solution bag, surgical packaging, intravenous injection sets, dialysis devices, catheter bottles, connectors and cannulae, polymethylmethacrylate (MMA) used for blood pump and reservoirs, membrane for blood dializer, implantable ocular lens and bone cement, styrene polymers used for tissue culture wares, roller bottles, vacuum canister, filterwares, clamps, blood dialyzers, diagnostic test kits, polyesters such as polyethyleneterephthalate (PET) used for implantable suture, mesh, artificial vascular grafts and heart valve, polytetrafluoroethylene (PTFE) used for catheter and artificial vascular grafts, polyamides (Nylon) used for packaging film, catheters, sutures and mold parts, natural rubbers used for fabrication of implants, polyacetal and polysulfone used for implant materials, and polycarbonate used for food packaging.

Industrial Applications

Water cooling towers, air conditioning duct and humidifiers, automotive OEM coating compositions, automotive refinish coating compositions, industrial coating compositions, architectural coating compositions, coil coating compositions, protective and marine coating compositions, and aerospace coating compositions, among others.

Other Additives

There are numerous other additives which can be added to the inventive composition depending upon the final composition.

Thus other additives would include flow aids, catalysts, wetting aids, pigments, rheology control agents, dyes, solvents, reactive diluents, adhesion promoters, antimicrobials, fungicides, mildewicides, stabilizers such antioxidants and light stabilizers, anti-yeast additives, adhesion promoters and preservatives

In addition to the components a) and b) other preservatives, known antimicrobials and biocides may be added such as for example chlorhexidine, chlorhexidine gluconate, glutaral, halazone, hexachlorophene, nitrofurazone, nitromersol, povidone-iodine, thimerosol, C₁- to C₅-parabens, hypochlorite salts, clofucarban, clorophene, poloxamer-iodine, phenolics, mafenide acetate, aminacrine hydrochloride, quaternary ammonium salts, oxychlorosene, metabromsalan, merbromin, dibromsalan, glyceryl laurate, pyrithione salts, sodium pyrithione, zinc pyrithione, dodecyl)(diethylenediamine)glycine, (dodecyl)(aminopropyl)glycine, phenol, m-cresol, o-cresol, p-cresol, o-phenyl-phenol, resorcinol, vinyl phenol, polymeric guanidines, polymyxins, bacitracin, circulin, octapeptins, lysozmye, lysostaphin, cellulytic enzymes, vancomycin, ristocetin, actinoidins, avoparcins, tyrocidin A, gramicidin S, polyoxin D, tunicamycin, neomycin, streptomycin, or any combination thereof. In particular the inventive combination may be combined with diphenyl ethers such as Triclosan® or Diclosan® registered trademarks of BASF Corporation.

Other antimicrobial active substances which may be combined with the inventive combination are phenol derivatives, benzyl alcohols, chlorhexidine, C₁₂-C₁₄ alkylbetaines, C₈-C₁₈ fatty acid amido alkyl-betaines, trihalocarbanilides and quaternary ammonium salts, for example [3-trimethoxysilyl)propyloctadecyl-dimethylammonium chloride.

### EXAMPLES

### Materials

Component a)
Ag1 is a silver composite which is a mixture of magnesium-sodium-boron-phosphate-glass incorporating silver-ions and zinc zeolite. The Ag⁺ concentration is 1.1 wt. % and the Zn²⁺ concentration varies from 3 to 3.6 wt. % of the composite. The wt. % is based on the total weight of the composite.
Ag2 is a Ag⁺ and Zn²⁺ in a zeolite of sodium-aluminum silicate. The silver ion content is approximately 3.5 wt. % and the zinc ion content is about 6.5 wt. %. The wt. % is based on the total weight of the composite.
Component b) is a homopolymer of tert-butylaminoethylmethacrylate (tBAEMA) from examples 1, 2 and 3 of varying molecular weight.
Component (c) polymeric matrix of varying composition—see application examples below.
Component (d) is quaternary ammonium compound of structure

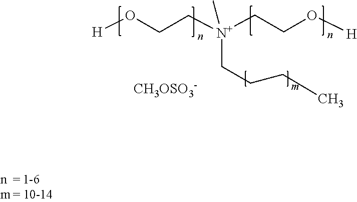

Test Organisms:
Staphylococcus aureus ATCC#6538
Staphylococcus aureus MRSA ATCC#33591
Pseudomonas aeruginosa ATCC#27853
Escherichia coli ATCC#8739

Test Method

Modified JIS Z 2801:

Hard surfaces possibly exhibiting antimicrobial activity are inoculated with 10 ml of a defined cell count of 10⁸ cfu/ml of a specific test organism and covered with a microscope cover slip in order to achieve good contact between the inoculum and a 1 in² surface area. The Inoculum is made in 1:500 Nutrient Broth and 100 is added directly to the sample surface. After 2 hour incubation, at 37° C. in a humid chamber followed by neutralization with SCDLP, the cell count on the antimicrobial surface is determined after elution via agar incorporation method and compared to a control which does not contain any antimicrobial.

Synthesis of Component (b)

### Example 1

### Synthesis of Homopolymer of Tert-Butylaminoethylmethacrylate (tBAEMA) Via ATRP

Into a 50 mL three neck round bottom flask reactor are charged 0.1549 g (0.1 mMole) of CuBr, 0.075 g (0.02 mMole) of CuBr₂, 0.342 g of tris[2-(dimethylamino)ethyl]amine (Me₆TREN) and 5.50 g of dimethyl sulfoxide (DMSO). The reactor content is mixed and sparged with nitrogen for about 10 minutes. At the same time, 18.28 g (0.1 mole) of t-butylaminoethyl methacrylate (tBAEMA) and 1.93 g (0.01 mole) Ethyl 2-bromoisobutyrate (EBiB) are mixed and sparged with nitrogen in a drop funnel for 10 minutes. The reactant content in the drop funnel is added to the reactor under nitrogen sparging to start polymerization. After polymerization under nitrogen for about 2 hours, the reactor content is precipitated in 300 mL of hexane and stirred overnight. The residual catalysts are removed from bottom DMSO phase and the polymer is recovered from the hexane phase through rotary evaporation. The polymer is re-dissolved in 10 g of DMSO and precipitated in fresh boiling hexane again to further remove residual monomer and catalysts. The polymer was recovered again by rotary evaporation and then dried in a vacuum oven at 50° C. overnight. The purified polymer product is analyzed with gel permeation chromatography (GPC) to have a number average molecular weight (Mn) of 2,700 and a weight average molecular weight (Mw) of 4,500 using poly(methyl methacrylate) monodisperse molecular weight standards from Polymer Labs. The molecular weight polydispersity index (PDI=Mw/Mn) is 1.67.

### Example 2

### Preparation of tBAEMA Polymer (Mw of 174,000)

Following the procedure described in Example 1 of U.S. Pat. No. 6,096,800 using azobisisobutyronitrile (AIBN) initiator and tetrahydrofuran (THF) solvent, a tBAEMA homopolymer was prepared and characterized by GPC to have a weight average molecular weight (Mw) of 174,000 and a number average molecular weight of 63,000 (polydispersity index Mw/Mn=2.75).

### Example 3

### Preparation of tBAEMA Polymer (Mw of 91,000)

Following the same procedure of Example 2 except double the amount of the THF solvent to low the initial monomer concentration, a lower MW tBAEMA homopolymer was prepared and characterized by GPC to have a weight average molecular weight (Mw) of 91,000 a number average molecular weight of 12,000 (polydispersity index Mw/Mn=7.40).

Preparation of tBAEMA homopolymers by conventional radical polymerization process. 480 g of tetrahydrofuran (THF) solvent are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 120 g of t-butylaminoethyl methacrylate (tBAEMA) monomer (M) and an initiator solution (I) comprising 10 g of AIBN (azobisisobutyronitrile) and 100 g of THF are added to the reactor slowly over about 180 minutes. The reactor is maintained at reflux temperature under nitrogen blanket and agitation during the (I) feed and for additional 3 hours after the feeds. The reactor content is cooled down to room temperature. The reactor content is precipitated in 2 L of heptane. The polymer product is removed by filtration, washed with 500 mL of fresh heptane and dried in a vacuum oven at 50° C. for overnight. The polymer product is analyzed with gel permeation chromatography (GPC) to have a number average molecular weight (Mn) of 4,500 g/mole and a weight average molecular weight (Mw) of 11,000 g/mole using poly(methyl methacrylate) monodisperse molecular weight standards from Polymer Labs. The molecular weight polydispersity index (PDI=Mw/Mn) is 2.47.

### Example 4

### Preparation of tBAEMA Homopolymers by Conventional Radical Polymerization Process

480 g of tetrahydrofuran (THF) solvent are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 120 g of t-butylaminoethyl methacrylate (tBAEMA) monomer (M) and an initiator solution (I) comprising 6 g of AIBN (azobisisobutyronitrile) and 60 g of THF are added to the reactor slowly over about 60 minutes. The reactor is maintained at reflux temperature under nitrogen blanket and agitation during the (I) feed and for additional 3 hours after the feeds. The reactor content is cooled down to room temperature. The reactor content is precipitated in 2 L of heptane. The polymer product is removed by filtration, washed with 500 mL of fresh heptane and dried in a vacuum oven at 50° C. for overnight. The polymer product is analyzed with gel permeation chromatography (GPC) to have a number average molecular weight (Mn) of 13,400 g/mole and a weight average molecular weight (Mw) of 37,500 g/mole using poly(methyl methacrylate) monodisperse molecular weight standards from Polymer Labs. The molecular weight polydispersity index (PDI=Mw/Mn) is 2.80.

### Example 5

### Preparation of tBAEMA Homopolymers by Conventional Radical Polymerization Process

160 g of tetrahydrofuran (THF) solvent and 40 g of t-butylaminoethyl methacrylate (tBAEMA) monomer (M) are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., an initiator solution (I) comprising 0.4 g of AIBN (azobisisobutyronitrile) and 40 g of THF are added to the reactor slowly over about 60 minutes. The reactor is maintained at reflux temperature under nitrogen blanket and agitation during the (I) feed and for additional 3 hours after the feeds. The reactor content is cooled down to room temperature. The reactor content is precipitated in 1 L of heptane. The polymer product is removed by filtration, washed with 300 mL of fresh heptane and dried in a vacuum oven at 50° C. for overnight. The polymer product is analyzed with gel permeation chromatography (GPC) to have a number average molecular weight (Mn) of 54,500 g/mole and a weight average molecular weight (Mw) of 135,000 g/mole using poly(methyl methacrylate) monodisperse molecular weight standards from Polymer Labs. The molecular weight polydispersity index (PDI=Mw/Mn) is 2.62

### Example 6

### Preparation of Low MW tBAEMA Homopolymer with Narrow Molecular Weight Distribution by Conventional Radical Polymerization Process

4800 g of tetrahydrofuran (THF) solvent is charged to a 10 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 1200 g of t-butylaminoethyl methacrylate (tBAEMA) monomer (M) and an initiator solution (I) comprising 150 g of AIBN (azobisisobutyronitrile) and 1500 g of THF are added to the reactor slowly over about 180 minutes. The reactor is maintained at reflux temperature under nitrogen blanket and agitation during the M and I feeds and for additional 3 hours after the feeds. Monomer conversion is more than 95% after the polymerization reaction. The reactor content is heated to distill out about 5000 g of solvent. Fresh THF solvent (2000 g) is added to the reactor and distillation of solvent out of the reactor is repeated until residual monomer is less than 1%. The reactor content is cooled down to room temperature. The final solution polymer product contains 75% polymer solids. The polymer product is analyzed with gel permeation chromatography (GPC) to have a number average molecular weight (Mn) of 2,850 g/mole and a weight average molecular weight (Mw) of 6,900 g/mole using poly(methyl methacrylate) monodisperse molecular weight standards from Polymer Labs. The molecular weight polydispersity index (PDI=Mw/Mn) is 2.42.

### Application Examples

### Example 7

### Combination of Component (a), (b) and (d) in an Acrylic Carbamate (Component c)

A one-component acrylic thermoset clearcoat based on an acrylic carbamate crosslinked with an alkoxylated melamine is used as the polymer system into which are incorporated the instant combination (a), (b) and (a), (b) and (d) as well as each component alone.

All percentages are based on active additive and coating polymer solids.

Component (b) molecular weight: Mw=6930; Mw/Mn=2.85 example 6.

Each coating formulation is applied by drawdown with wire wound rod onto transparent glass microscope slides approximately 1″×3″ to a film thickness of about 35-45 microns dry film thickness. Eight replicate slides of each formulation are produced.

TABLE 1
Example 7 formulations of (a), (b) and (d) in acrylic carbamate
crosslinked with an alkoxylated melamine (c)

| | | Bake | | Hardness |
|---|---|---|---|---|
| Formulation | Additive | Temperature | Bake Time | (KHN) |
| A | None | 140° C. | 30 minutes | 16 |
| B | 27.3% Ag1 (0.3% | 140° C. | 30 minutes | 16 |
| | Ag+) | | | |
| C | 6% example 6 | 140° C. | 30 minutes | 8.4 |
| D(1) | 15% Compound d | 140° C. | 30 minutes | 4.3 |
| D(2) | 15% Compound d | 160° C. | 30 minutes | 9.5 |
| E(1) | 13.7% Ag1 + 3% | 140° C. | 30 minutes | 9.6 |
| | example 6 | | | |
| F(1) | 13.7% Ag1 + | 140° C. | 30 minutes | 9.4 |
| | 7.5% compound d | | | |
| G (1) | 3% example 6 + | 140° C. | 30 minutes | 3.0 |
| | 7.5% compound d | | | |
| G(2) | 3% example 6 + | 160° C. | 30 minutes | 10.9 |
| | 7.5% compound d | | | |
| H(1) | 9.1% Ag1 + 2% | 140° C. | 30 minutes | 6.2 |
| | example 6 + 5% | | | |
| | compound d | | | |
| H(2) | 9.1% Ag1 + 2% | 160° C. | 30 minutes | 14.0 |
| | example 6 + 5% | | | |
| | compound d | | | |

Ag1 is a mixture of glass with incorporated Ag⁺ and a zinc-zeolite. The composite carries about 1.1 wt. % Ag⁺ and about 3-4 wt. % Zn⁺². Thus 27.3 g of the composite of Ag⁺ is equivalent to about 0.3 wt. % Ag⁺ in the formulation.

Two slides of each formulation, plus triplicate blank glass slides controls are subjected to antimicrobial activity evaluation via a modified version of JIS Z2801 industry standard, against E. coli, P. aeruginosa, and Methicillin-resistant S. aureus (MRSA) bacteria using a 2 hour incubation period. See modified method above.

The results of antimicrobial testing may be expressed as log₁₀ reduction of colony forming units (CFU's) vs the blank glass slide control. These results are as follows:

TABLE 2
The coated slides are prepared and tested as in Example 7.

| | | log₁₀ | log₁₀ | log₁₀ |
|---|---|---|---|---|
| | | reduction | reduction vs | reduction |
| | | vs E. coli | P. aeruginosa | vs MRSA |
| Formulation | Additive | 2 hours | 2 hours | 2 hours |
| Blank Glass | | — | — | — |
| Control | | | | |
| A | None | 0.58 | 0.0 | 0.09 |
| B | 27.3% Ag1 | 0.24 | 0.7 | 0.03 |
| | (0.3% Ag+) | | | |
| C | 6% example 6 | 0.8 | 0.75 | 0.7 |
| D(1) | 15% Compound | 4.5 | 0.4 | 3.3 |
| | d(140 C.) | | | |
| D(2) | 15% Compound | 4.7 | 0 | 3.1 |
| | d (160 C.) | | | |
| E(1) | 13.7% Ag1 + 3% | 5.9 | 5.8 | 3.8 |
| | example 6 | | | |
| F(1) | 13.7% Ag1 + | 2.3 | 0 | 1.3 |
| | 7.5% compound d | | | |
| G(1) | 3% example 6 + | 5.9 | 0.3 | 4.4 |
| | 7.5% compound d | | | |
| G(2) | 3% example 6 + | 1.8 | 0 | 2.2 |
| | 7.5% compound d | | | |
| H(1) | 9.1% Ag1 + 2% | 5.3 | 5.8 | 3.5 |
| | example 6 + 5% | | | |
| | compound d | | | |
| H(2) | 9.1% Ag1 + 2% | 4.1 | 3.4 | 2.0 |
| | example 6 + 5% | | | |
| | compound d | | | |

These data show that the combination of the first polymer and silver (E1) exhibits improved antimicrobial activity verses either compound alone (B, C or D), even with much higher levels in the single-actives formulations. This improved activity is apparent in all three bacteria.

The above example shows that a 3-way combination (H series) at reduced levels also exhibits significantly improved performance verses any of the compounds alone at high levels, or combinations of the silver or example 6 with compound d (F or G series). This also exemplifies the synergistic effect of the silver and the polymer of example 6 (E1).

### Example 8

A one-component acrylic thermoset clearcoat based on an acrylic carbamate crosslinked with an alkoxylated melamine is used as the polymer system into which are incorporated the instant combination (a) and b). The slides are made as in example 7 above.

TABLE 3
Additional Formulations of a one-component acrylic thermoset clearcoat

| | | | | Pendulum |
|---|---|---|---|---|
| For- | | Bake | | Hardness |
| mulation | Additive | Temperature | Bake Time | (sec) |
| A | None | 140° C. | 30 minutes | 168 |
| E(2) | 14.5% Ag1 + 3.3% | 140° C. | 30 minutes | 133 |
| | example 6 | | | |
| E (3) | 22.2% Ag1 + 4.9% | 140° C. | 30 minutes | 120 |
| | example 6 | | | |
| E (4) | 14.5% Ag1 + 5.4% | 140° C. | 30 minutes | 122 |
| | example 6 | | | |
| G (3) | 2.2% example 6 + | 160° C. | 30 minutes | 87 |
| | 10.9% compound d | | | |
| H (3) | 14.5% Ag1 + 3.3% | 140° C. | 30 minutes | 58 |
| | example 6 + 8.1% | | | |
| | compound d | | | |
| H (4) | 14.5% Ag1 + 3.3% | 160° C. | 30 minutes | 90 |
| | example 6 + 8.1% | | | |
| | compound d | | | |

TABLE 4
The coated slides are prepared and tested as in Example 7.

| | | log₁₀ | log₁₀ | log₁₀ |
|---|---|---|---|---|
| | | reduction | reduction vs | reduction |
| For- | | vs E. coli | P. aeruginosa | vs MRSA |
| mulation | Additive | 2 hours | 2 hours | 2 hours |
| Blank | | — | — | — |
| Glass | | | | |
| Control | | | | |
| A | None | 0.15 | 0 | 0.4 |
| E(2) | 14.5% Ag1 + 3.3% | 4.8 | 0.98 | 2.0 |
| | example 6 | | | |
| E (3) | 22.2% Ag1 + 4.9% | 6.5 | 4.10 | 3.2 |
| | example 6 | | | |
| E(4) | 14.5% Ag1 + 5.4% | 6.5 | 5.37 | 2.5 |
| | example 6 | | | |
| G(3) | 2.2% example 6 + | 6.5 | 0 | 4.4 |
| | 10.9% compound d | | | |
| H (3) | 14.5% Ag1 + 3.3% | 6.5 | 4.8 | 4.2 |
| | example 6 + 8.1% | | | |
| | compound d | | | |
| H (4) | 14.5% Ag1 + 3.3% | 6.5 | 4.0 | 3.1 |
| | example 6 + 8.1% | | | |
| | compound d | | | |

In Table 5 two slides of each formulation, plus triplicate blank glass slides controls are subjected to antimicrobial activity evaluation via a modified version of JIS Z2801 industry standard, P. aeruginosa, bacteria. The previous 2 hour incubation period is replaced by a time series, with SCDLP neutralization and agar plating performed at intervals of 10, 30, 60, and 120 minutes. See modified method above. The slides are made as in example 7 above.

TABLE 5
Results of antimicrobial testing for example 7 - kinetic “kill rate” study
log₁₀ reduction vs P. aeruginosa

| | | log₁₀ reduction | | | |
|---|---|---|---|---|---|
| | | vs P. aeruginosa | | 60 | 120 |
| Formulation | Additive | 10 min | 30 min | min | min |
| Blank Glass | | — | — | — | — |
| Control | | | | | |
| A | None | 0.00 | 0.00 | 0.00 | 0.00 |
| B | 27.3% Ag1 | 0.00 | 0.00 | 0.00 | 0.00 |
| | (0.3% Ag+) | | | | |
| C | 6% example 6 | 0.00 | 0.00 | 0.00 | 0.00 |
| E(1) | 13.7% Ag1 + | 0.00 | 0.00 | 2.97 | 3.40 |
| | 3% example 6 | | | | |

These data show that the combination of the first polymer and silver exhibits (E1) significant kill in as little as one hour verses either compound alone, even with much higher levels in the single-actives formulations.

### Example 9

The testing below is carried out as in example 7 above.

TABLE 6
A one-component acrylic thermoset clearcoat based on an acrylic
polyol crosslinked with a partially alkoxylated melamine is used
as the polymer system (c) into which are incorporated the instant
combination (a), (b), and (d), as well as compound (d) alone.

| | | | | Pendulum |
|---|---|---|---|---|
| For- | | Bake | | Hardness |
| mulation | Additive | Temperature | Bake Time | (sec) |
| A | None | 140° C. | 30 minutes | 215 |
| D (3) | 20% compound d | 140° C. | 30 minutes | 202 |
| H (5) | 13.6% Ag1 + 3.0% | 160° C. | 30 minutes | 197 |
| | example 6 + 7.5% | | | |
| | compound d | | | |
| H(6) | 13.6% Ag1 + 3.0% | 140° C. | 30 minutes | 199 |
| | example 6 + 7.5% | | | |
| | compound d | | | |

TABLE 7
The results of antimicrobial testing may be expressed as log₁₀
reduction of colony forming units (CFU's) verses the blank
glass slide control. These results are as follows:

| | | log₁₀ | log₁₀ | log₁₀ |
|---|---|---|---|---|
| | | reduction | reduction vs | reduction |
| | | vs E. coli | P. aeruginosa | vs MRSA |
| Formulation | Additive | 2 hours | 2 hours | 2 hours |
| Blank Glass | | — | — | — |
| Control | | | | |
| A | None | 0 | 0.9 | 0.1 |
| D(3) | 20% compound d | 0 | 1.0 | 1.0 |
| H (5) | 13.6% Ag1 + 3% | 2.7 | 3.7 | 3.7 |
| | example 6 + | | | |
| | 7.5% compound d | | | |
| H(6) | 13.6% Ag1 + 3% | 4.6 | 6.2 | 5.8 |
| | example 6 + | | | |
| | 7.5% compound d | | | |

### Example 10

Masterbatches of the polymer of example 6 and/or Ag in glass/Zn²⁺ are prepared by blending with ground thermoplastic polyurethane (Elastollan 1190A resin) in a Turbula® mixer. The mixture is dried at 80° C. overnight, and compounded on a Leistritz® 18 mm twin screw extruder at 205° C. (400° F.). The masterbatches are then Turbula® blended with unprocessed resin to prepare 1.0% total the formulations, which are dried (80° C./overnight) and compounded on a Leistritz® 18 mm twin screw extruder at 205° C. (400° F.). The formulations are compression molded (10 cm×10 cm×250 μm) and cut into 5 cm×5 cm sample plaques for JIS Z 2801 testing (in duplicate).

The resulting thermoplastic composition is examined for antimicrobial activity verses the antimicrobial activity of the polymer of example 6 and the silver/zeolite composite alone. Loading levels are 1% of each for the incubation time (5 hours) under JIS Z 2801 Testing conditions.

Log Reduction in 5 Hour JIS Z 2801 Test

| | 1.0% polymer | 1.0% Blend | 1.0% |
|---|---|---|---|
| | example 6 | (1:1) | silver/zeolite* |
| E. coli | 0.9 | 3.2 | 0.2 |
| S. aureus | 0.1 | 1.5 | 0.9 |

*The silver/zeolite composite is Ag2. Concentration of the ionic silver in the composite is about 3.5 wt. % ± .5% and the zinc ionic content is about 6.5 ± .7% wt. %.

### Example 12

### Additional Activity of Combinations of Component (a) and (b) in a Thermoplastic Lacquer Coating

A 40% solution of Paraloid B66 (a thermoplastic acrylic copolymer) is prepared by dissolving 40 g of solid polymer in 60 g of xylene and agitating on a rolling mixer until completely dissolved. The instant compounds are incorporated at the levels indicated in the formulation below. Each formulation is applied to glass slides using a wire wound rod, and allowed to air dry.

The final additive levels of the air dried formulations are as follows:
1. Blank—no additive
2. 27.3% Ag1 (0.3% Ag+)
3. 6% example 6
4. 13.7% Ag1+3% example 6

Various Coating Application Examples

A One-Component Acrylic Urethane Clearcoat

The component a) Ag2 and b) example 2 are formulated using acrylic polyol and blocked isocyanate. The system is catalyzed with 0.02% by weight of dibutyltin dilaurate based on the total resin solids. The component a) Ag2 and first polymer from example 1 are added at the appropriate level prior to application.

Steel panels 3″×4″ primed with an electrocoat primer are then coated with a light blue metallic basecoat, then with the stabilized clearcoat. The basecoat is spray applied to a thickness of 1.0 mil (25 microns) dry film thickness and the stabilized clearcoat is then applied to a thickness of 2.0 mils (50 microns) dry film thickness. The coating is baked and cured at elevated temperatures.

Coatings over Plastic Substrates

Each coating formulation containing components a) and b) is applied by an automatic spray apparatus onto Reacting Injection Molded substrate of a TPO (thermoplastic polyolefin). Both substrates are in form of 4″.times.12″ plaques. Each coating is applied to achieve a dry film thickness of approximately 2.0 mils (50 microns). The coatings are cured by baking at 250.degree. F.)(121 C° for 20 minutes.

Waterborne Varnish

Waterborne coating comprise a significant and increasing proportion of the coating in use for a wide variety of applications including automotive basecoats, industrial coatings and trade sale coatings. These coatings may be pigmented or transparent.

The components a) Ag2 and b) example 2 are incorporated into a waterborne dispersion by pre dissolution in a cosolvent blend. The waterborne dispersion is a commercially available acrylic/urethane hybrid resin. The co-solvent blend is a 1:1 mixture of TEXANOL® (2,2,4-trimethyl-1,3-pentanediol, Texaco) and ARCOSOLVE® TPM (tripropylene glycol methyl ether, AtlanticRichfield).

0.45 gram of a stabilizer is predissolved in 10 g of the cosolvent blend which is then incorporated into the following composition:

ppw FLEXTHANE 630 (Air Products) 100.0 Foamaster VF 0.1 Water 10.0 TEXANOL®/ARCOSOLVE®/hindered amine 10.5 UV absorber (TINUVIN 1130, Ciba) 1.2 BYK® 346 0.5 MICHEMLUBE® 162 2.0

Each coating is brush applied onto 6″×6″ sections of cedar and pine boards. The weight of the coating applied is regulated by weighing the coating and brush before and after application and ensuring that the same weight of coating is applied to each section.

The coated board sections are allowed to dry at ambient temperature.

ABS Molding Applications

Thermoplastic materials composed of mixtures of copolymers derived from the copolymerization of styrene monomer with acrylonitrile and the copolymerization of styrene monomer with butadiene, generally referred to as ABS, are dry blended with the a) Ag1 and b) first polymer from example 6 and melt compounded into pellets. Typical formulations contain the instant compounds at levels from 0.05% to 2.0%, a metal stearate such as calcium stearate at 0.05% to 0.5%, pigments from 0% to 5%, UV absorbers at levels of 0.05% to 2.0%, phosphites at 0.0%-0.1%, phenolic antioxidants at 0.0%-1.25%, N,N-dialkylhydroxylamine at 0.0%-0.1%, and optionally other hindered amine stabilizers at levels of 0.0% to 2.0%.

The pelletized fully formulated resin is then processed into a useful article such as extrusion into sheet, film, profiles and pipe; molded into bottles; injection molded into a molded article; thermoformed into molded articles; or rotational molded into hollow articles.

HIPS Molding Applications

Molding grade high impact polystyrene is dry blended with a) Ag2 and b) first polymer from example 4 and then melt compounded into pellets. In addition to the instant compounds, selected flame retardants are also included. The flame retardants are tris[3-bromo-2,2-bis(bromomethyl)propyl]phosphate, decabromodiphenyl oxide, ethylene bis(tetrabromophthalimide) and ethylene bis(dibromonorbornanedicarboximide). The pelletized fully formulated resin is then injection molded into test specimens using a BOY 50M laboratory model injection molder.

Polyester/Melamine Based Coil Coating

A white polyester/melamine based oilfree alkyl coil coating is utilized in this example. The fully formulated paint with Ag1 and Ag2 with polymer of examples 1 and 2 are applied over a primed steel sheet using a wire wound rod to give 0.6-0.8 mil dry film. The panels are baked for about 90 seconds at 220° C., removed from the oven and immediately quenched in water.

Thermoplastic Urethane (TPU) Substrate Containing

Thermoplastic urethane (TPU) (Elastollan 1190A) from BASF is used as matrix polymer. TPU blend containing TBAEMA polymer from example 6 and Ag1 is obtained by melt extrusion compounding in a twin screw extruder with temperature setting from 195 to 205° C. and pelletized. TPU plaques (25×25 cm²) of 1.5 mm thickness are prepared by compression molding of the TPU pellets at 200° C. and used for evaluation of biocidal activity.

High Consistency Silicone Rubber Formulation

The high consistency rubber is a two component system supplied by NuSil® (www.NuSil.com). Part A contains the polydimethylsiloxane polymer and a platinum catalyst while part B contains the cross-linking agent.

Part A (27.3 g) and Part B (29.1 g) of MED-4750 is added to a 2 roll-mil Brabender set at 60 rpm. The resulting formulation is mixed for 1 minute. The Ag1 (wt. % ranging from 0.01 wt. % to about 1 wt.) and first polymer of example 3 (wt. % ranging from about 0.5%-40%, preferably 1-10% based on the total weight of the silicone) are slowly added neat at the weight percents varying from to the Brabender with continuous mixing. The resulting formulation is mixed for an additional 2 minutes after all of the silver and Al are added. The Brabender is shut off and the silicone rubber is manually removed from the mixing chamber.

The silicone formulation is compression molded into plaques. A sheet of aluminum is placed on the first metal plate followed by a sheet of Mylar®. The material is cured at 116° C. (240° F.) for ten minutes at a pressure of 28 tons. After ten minutes, the platen is moved to the cooling chamber and again compressed for ten minutes at a pressure of 28 tons. The plaques are removed after ten minutes from the mold.

In addition to the plaques, molded tubing is also prepared and tested.

Typically tubing is formed by mixing Part A and B together with the additives and then put through the extruder for curing and processing into tubing. Once the tubing is prepared, it may be post-cured in an oven to complete the cure and remove any by-products. Both the tubing and plaques are pretreated with artificial urine and tested for antimicrobial activity as in ASTM 2149.

1. An antimicrobial polymeric coating composition or a polymeric molding composition comprising
(a) An antimicrobial metal;
(b) about 0.1 to about 20 wt. % of a first polymer containing a monomer unit of formula (I) 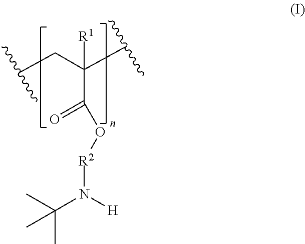
wherein R¹ is H or CH₃,
R² is C₁-C₅ alkyl bi-radical,
and
n is a number from 3 to 10,000;
(c) a second polymer which is a film-forming polymer or a thermoplastic polymer,
and
(d) optionally, a quaternary ammonium compound,
wherein the wt. % is based on the total weight of (c) and (c) is different than the first polymer of component (b).

2. The antimicrobial polymeric coating composition or the polymeric molding composition according to claim 1, wherein the first polymer (b) is a homopolymer and formed from tert-butylaminoethyl(meth)acrylate (tBAEMA).

3. The antimicrobial polymeric coating composition or the polymeric molding composition according to claim 1 wherein the antimicrobial metal of component (a) is selected from the group consisting of zinc, copper, elemental silver, colloidal silver and, silver compounds selected from group consisting of silver nitrate, silver citrate, silver sulfadiazine, silver acetate, silver sulphate, silver chloride, silver oxide, silver complexes; silver metal-containing zeolites, silver metal-containing glasses and silver-silica composites.

4. The antimicrobial polymeric coating or the polymeric molding composition according to claim 3, wherein the antimicrobial metal of component (a) is selected from elemental silver, colloidal silver and silver compounds selected from the group consisting of silver nitrate, silver citrate, silver sulfadiazine, silver acetate, silver sulphate, silver chloride, silver oxide, silver complexes; silver metal-containing zeolites, silver metal-containing glasses and silver-silica composites.

5. The antimicrobial polymeric coating composition or the polymeric molding composition according to claim 1, wherein the first polymer of component (b) is a co-polymer formed from the monomer unit of formula (I), which monomer unit of formula (I) comprises about 30 wt. % to about 98 wt. % of the total weight of the co-polymer.

6. The antimicrobial polymeric coating composition or the polymeric molding composition according to claim 4,
wherein the silver
if in the neutral state (elemental silver for example), the weight will range from about 0.05 wt. % to about 10 wt. %;
if in the ionic state (for example Ag⁺, Zn⁺², Cu⁺¹ or Cu⁺²), the wt. % will range from about 0.005 wt. % to about 1 wt. % and the basis is the total weight of the polymer (c) in the composition.

7. The antimicrobial polymeric coating composition or the polymeric molding composition according to claim 1, wherein the first polymer (b) has a weight average molecular weight ranging from about 500 to about 2,000,000 g/mole.

8. The antimicrobial polymeric coating composition or the polymeric molding composition according to claim 1, wherein
if the antimicrobial metal (a) is in ionic state the weight ratio of (b) to (a) will range from about 100 to about 1,
and
if the antimicrobial metal (a) is in the neutral form, the weight ratio of (b) to (a) will range from about 100 to about 10.

9. The antimicrobial polymeric coating composition or the polymeric molding composition according to claim 8, wherein the antimicrobial metal is silver in ionic form and the weight ratio of (b) to (a) will range from about 30 to 15 to 1.

10. The antimicrobial polymeric coating composition or the polymeric molding composition according to claim 1 wherein the composition is a coating composition.

11. The antimicrobial polymer coating composition or polymeric molding composition according to claim 1, wherein the composition is a molding composition.

12. The coating composition of claim 9, wherein (c) is a film forming polymer which is a thermoset or crosslinked polymer.

13. The molding composition according to claim 11 wherein (c) is a thermoplastic and selected from the group of polymers consisting of polysiloxane, siliconE rubber, polyolefins, polyvinylchloride, polymethylmethacrylate, polyesters, polytetrafluoroethylene, polyamides, natural rubbers, polyacetal, polysulfones, polyurethanes, thermoplastic polyurethanes (TPU), polyethers, styrene/acrylic resins and polycarbonates.

14. The coating composition according to claim 10, wherein (c) is a film forming polymer selected from the group consisting of acrylic resin stoving, lacquers or thermosetting resins including acrylic/melamine systems, polyester lacquers, alkyd resin lacquers, lacquers based on alkyd/melamine resins, alkyd/acrylic/melamine resins, acid-catalyzed baked finishes, non-acid catalyzed thermoset resins such as epoxy, epoxy-polyester, vinyl, alkyd, acrylic and polyester resins, optionally modified with silicon, isocyanates or isocyanurates, UV-cured coating systems using unsaturated acrylic resins, polyurethane acrylates, epoxy acrylates, polyester acrylates, unsaturated polyester/styrene resins and silyl acrylates.

15. The antimicrobial polymeric coating composition or polymer molding composition according to any of the preceding claims, wherein the component (c) a film-forming polymer or a thermoplastic polymer and (c) ranges from at least 30 to about 98 wt. % and
the weight % basis of (c) is the total weight of the solids in the polymeric coating composition or the polymeric molding composition.

16. The antimicrobial polymer coating composition or polymeric molding composition according to claim 1, which includes about 0.1 to about 30 wt. % component (d) of formula (II) 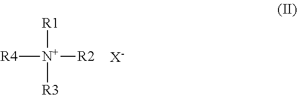
wherein R₁, R₂, R₃ and R₄ are independent of each other C₁₋₄₀ alkyl, said alkyl substituted by one or more hydroxy or benzyloxy group and/or interrupted by one or more oxygen,
C₇₋₁₅ aralkyl, or said aralkyl substituted by one or more C₁₋₂₀ alkyl, hydroxy,
C₁₋₂₀alkyloxy and/or benzyloxy groups or any two of adjacent R₁, R₂, R₃, R₄ may form a five or six membered nitrogen containing ring which may be saturated or unsaturated,
and
X⁻ is a halide, hydroxide, phosphate, phosphonate, carbonate, sulfate or carboxylate anion and the wt. % is based on the weight of component (c).

17. The antimicrobial polymer coating composition or polymeric molding composition according to claim 15, wherein the component (d) is of formula (III) below. 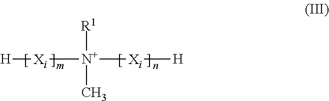
in which
R¹ is a straight-chain or branched alkyl radical, alkenyl radical, or alkadienyl radical having 6 to 30 carbon atoms,
m and n independently of one another are an integer from 1 to 20,
and
each Xᵢ for i=1 to m and 1 to n independently of one another is selected from the group consisting of —CH₂—CH₂—O—, —CH₂—CH(CH₃)—O—, and —CH(CH₃)—CH₂—O—, preferably —CH₂—CH₂—O—.

18. The antimicrobial polymer coating composition or polymeric molding composition according to claim 16, wherein the component (d) is

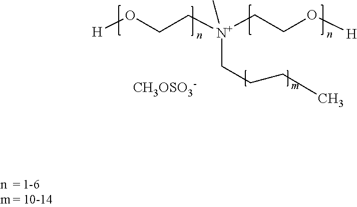

19. A method of improving the antimicrobial effectiveness of a polymeric coating composition or a polymeric molding composition by
combining (a), (b) (c) and optionally (d) as in claim 1.

20. A masterbatch comprising:
an antimicrobial metal in ionic form (a) and (b) a homopolymer of tBAEMA and (c) a thermoplastic polymer,
wherein the wt. ratio of (b) to (a) when (a) is about 40 to 1, wherein and (c) the thermoplastic makes up about 10 to about 90 wt. % and the wt. % is based on the total weight of the masterbatch.
